(19) United States
(12) Patent Application Publication
(10) Pub. No.: US 2016/0207738 A1
(43) Pub. Date: Jul. 21, 2016

(54) ELEVATOR SYSTEM

(71) Applicant: THYSSENKRUPP ELEVATOR AG, Essen (DE)

(72) Inventors: Bernd ALTENBURGER, Neuhausen (DE); Holger ZERELLES, Leinfelden-Echterdingen (DE); Darrell HERTEL, Aichtal (DE)

(73) Assignee: ThyssenKrupp Elevator AG, Essen (DE)

(21) Appl. No.: 15/025,595

(22) PCT Filed: Sep. 30, 2014
(86) PCT No.: PCT/EP2014/002653

§ 371 Date: Mar. 29, 2016

(30) Foreign Application Priority Data
Sep. 30, 2013 (DE) 10 2013 219 825.6

(51) Int. Cl. B66B 7/06; B66B 7/08

(52) U.S. Cl. CPC B66B 7/064; B66B 7/068; B66B 7/08

(57) ABSTRACT

An example elevator system may include at least one elevator cage that is displaceable in an elevator shaft, a connection means that has a first elevator cage-side end and a second end, and a suspension disposed on the elevator cage. The connection means may include, for instance, a balance chain or belt. The first end of the connection means may be fastened to the suspension on the elevator cage. Further, the example elevator system may include a support unit that exerts a force on the suspension that counteracts a force acting on the suspension due to a mass of the connection means. The support unit may include a rope, a deflection roller, and a counterweight, wherein the rope is fastened to the counterweight and the suspension and is guided over the deflection roller.

The present invention relates to an elevator installation having an elevator cage which is displaceable in an elevator shaft, wherein a connection means which has a first elevator cage-side end and a second end is provided, wherein the first end of the connection means is fastened to a suspension provided on the elevator cage.

### PRIOR ART

In conventional elevator installations having an elevator cage which is displaceable in an elevator shaft, the elevator cage is guided by way of a support means, for example at least one support rope or at least one support belt, said support rope or support belt, respectively, being guided over a drive pulley and deflection rollers and being connected to a counterweight. The elevator cage and the counterweight are displaceable along respective guides in the elevator shaft. The elevator cage is configured having guide rollers which interact with the elevator cage guide.

Moreover, a connection means is connected to the elevator cage. The connection means may be a suspended cable or a support-rope weight compensation means, for example. A support-rope weight compensation means is, for example, a balance chain, a balance belt, a balance strap, or a balance cable. For example, the elevator cage is supplied with electric power by means of a suspended cable. Moreover, data may be exchanged between the elevator cage and an external computer or controller, respectively, by way of the suspended cable. The changing stress by the weight force of the support rope when the position of the elevator cage changes is compensated for by means of a support-rope weight compensation means which connects the elevator cage to the counterweight.

Both the suspended cable as well as the support-rope weight compensation means, as connection means, are typically fastened to the lower side of the elevator cage. Thus, the weight force of the connection means additionally acts on the elevator cage, this potentially leading to non-uniform stresses on the guide rollers of the elevator cage.

The suspended cable is typically fastened to the lower side of the elevator cage, on the one hand, and to or in the elevator shaft, on the other hand. By contrast, the support-rope weight compensation means is typically fastened to the lower side of the elevator cage, on the one hand, and to the counterweight, on the other hand. However, the support-rope weight compensation means may also be fastened to the other side on or in the elevator shaft.

Additionally, the connection means, for example on account of the bending radius of the connection means that has to be adhered to, mostly acts in a decentralized manner, that is to say not on the central region or on the center of gravity of the elevator cage, respectively. Depending on the position of the elevator cage in the elevator shaft, a non-uniform distribution of force and momentum on the guide rollers of the elevator cage is thus created.

In order for good traveling properties and a high level of travel comfort to be guaranteed, the elevator cage must be precisely balanced. Therefore, a compensation mass may be fastened to the elevator cage in order for this variable distribution of force on account of the connection means to be compensated for. On account thereof, a torque which is exerted by the connection means on the guide rollers of the elevator cage, for example, may be compensated for, and the stress on the guide rollers may be reduced.

However, compensation of this type by means of a compensation mass is only optimal in a specific position of the elevator cage, mostly in the center of the elevator shaft. Non-uniform distribution of force on the guide rollers continues to arise in the other positions.

The highest stresses on the guide rollers on account of the non-uniform forces and momentums caused by the connection means arise at the uppermost and lowermost positions of the elevator cage in the elevator shaft. The complete weight force of the connection means acts on the elevator cage and, on account thereof an ultimately undesirable force acts on the guide rollers, in particular in the highest position. On account of the compensation mass, a force which leads to torque and ultimately to an undesirable force on the guide rollers is likewise present in the lowest position.

Alternatively, a symmetrical force acting on the elevator cage may also be achieved by using two connection means on mutually opposite sides of the elevator cage. However, this is associated with high costs and is also often impossible for reasons of space.

It is, therefore, desirable for a possibility to be provided in order for stresses which the connection means of an elevator cage exerts on the guide rollers of the elevator cage to be effectively minimized.

### DISCLOSURE OF THE INVENTION

An elevator installation having the features of independent patent claim 1 is proposed.

The elevator installation according to the invention has at least one elevator cage which is displaceable in an elevator shaft, wherein a connection means is connected to the elevator cage and a first elevator cage-side end of the connection means is fastened to a suspension provided on the elevator cage. The second end of the connection means is fastened in or to the elevator shaft, for example. Alternatively, the second end of the connection means is fastened to the counterweight.

The elevator installation according to the invention furthermore comprises an additional rope, wherein the additional rope is fastened to the suspension in such a manner that, on account thereof, a force that counteracts a weight force acting on the suspension by way of the connection means is exerted on the suspension.

The elevator cage here is connected to a counterweight in particular by way of a support rope. In particular, the support rope is guided over at least one drive pulley and/or deflection rollers or run-off rollers, respectively.

The connection means is preferably a suspended cable. The suspended cable serves in particular for supplying power to the elevator cage. Furthermore, the suspended cable possesses functions of a data cable in particular. By means of the suspended cable in particular data are thus transmitted to the elevator cage or from the elevator cage, respectively, and the elevator cage may be controlled by way of the suspended cable. The suspended cable here comprises in particular a plurality of individual lines which are assembled to form the suspended cable.

Alternatively, the connection means is a support-rope weight compensation means. The support-rope weight compensation means serves for equalizing the masses of the support means. The weight force acting on the drive pulley and/or deflection rollers or run-off rollers, respectively, varies depending on the position of the elevator cage, in particular in the case of great conveying heights. As soon as the elevator cage is in a lower position, the support means are substantially on the elevator cage side. However, if the elevator cage is at the upper end of the shaft, the support means are then substantially on the side of the counterweight. This variation leads to variable stress on the drive pulley and on the rollers. This variation is typically compensated for by a support-rope weight compensation means connecting the elevator cage to the counterweight. Depending on the position of the elevator cage, the support-rope weight compensation means now likewise switches between the elevator cage side and the counterweight side and in this manner compensates for the variation by way of the weight force of the support means.

The invention here is suitable for elevator installations having only one elevator cage as well as for elevator installations having a plurality of elevator cages, in particular a plurality of elevator cages within one elevator shaft.

### Advantages of the Invention

The first end of the connection means is not fastened directly to the elevator cage but to a suspension which is configured on said elevator cage. The suspension is in particular at least partially de-linked from the elevator cage.

In one variant, the connection means is a suspended cable. The suspension here is in particular designed in such a manner that the suspended cable or the individual lines of the suspended cable, respectively, are routed into the elevator cage. The suspended cable or the individual lines, respectively, in the elevator cage and/or on the shaft side are connected to corresponding construction elements, for example to control equipment, in particular. The supply of power or the transmission of data, respectively, is thus guaranteed by means of the suspended cable. A second end of the suspended cable is fastened in a conventional manner in the elevator shaft, in particular to a wall or to the ceiling of the elevator shaft. It is particularly expedient for the first end of the suspended cable to be fastened to the wall in the center of the vertical extent of the elevator shaft.

On account of the mass thereof, the connection means exerts a weight force on the suspension. This weight force of the connection means here acts on the suspension in a vertically downward direction. According to the invention, a support unit which exerts a force on the suspension that counteracts the weight force of the connection means acts on the suspension. The force acting by way of the support unit on the suspension will hereunder also be referred to as an additional force. The weight force of the connection means and the additional force here are in particular in an equilibrium of forces. In particular, a direction of the weight force and a direction of the additional force are thus mutually opposed. In particular, the values for the weight force and for the additional force are identical.

The support unit serves for compensating the weight force of the connection means. The weight force of the connection means is received by way of the support unit. Any torque which could be exerted by a connection means without a support unit of this type on an elevator cage is eliminated. It is thus in particular prevented that a non-uniform distribution of force and/or momentum is exerted on a guide and/or on guide rollers of the elevator cage. Non-uniform stress on the guide rollers by way of the connection means is thus effectively compensated for. Here, this compensation of the weight force of the connection means is optimal not only in one specific position of the elevator cage in the elevator shaft, but in any potential position of the elevator cage in the elevator shaft. On account thereof, the service life of the guide rollers is increased, for example, and repair or maintenance costs, respectively, are reduced. Furthermore, it is guaranteed that the elevator cage in any potential position in the elevator shaft is precisely balanced, enhancing traveling properties and travel comfort.

The support unit expediently lies at least partially or completely outside the vertical projection of the elevator cage. By way of this measure, the lower side of the elevator cage may be kept substantially free of units for fastening the connection means.

According to one preferred design embodiment of the elevator installation according to the invention, the support unit has an additional rope, one or a plurality of deflection rollers, and a counterweight, wherein the second end of the additional rope is fastened to the counterweight. The additional rope here is guided over the deflection roller(s). Speaking illustratively, the counterweight here receives the weight force of the connection means. The additional rope is thus tensioned by the connection means. The weight force of the connection means is transferred to the counterweight by way of the additional rope. In particular, a counterweight of the elevator cage that is already present anyway may be utilized as the counterweight for compensating for the weight force of the connection means. On account thereof, the additional rope may also be accommodated in a space-saving manner in the elevator shaft. The deflection roller of the support unit is preferably fastened in a machine room and/or in the shaft head of the elevator shaft. The additional rope may also be composed of a plurality of ropes or be embodied in the form of a belt.

It is particularly preferable that the suspension in relation to the elevator cage is configured so as to be movable, in particular vertically movable. By way of play which is thus made available to the suspension in relation to the elevator cage, de-linking of the connection means from the elevator cage is implementable. Variable elongation stresses between the support rope of the elevator cage and the additional rope during operation may thus be equalized.

The connection means is thus capable of being completely de-linked from the elevator cage, such that a guide, in particular guide rollers of the elevator cage, is/are not stressed. The elevator cage here is connected to the counterweight by way of the support rope and the drive pulley, or by one or a plurality of deflection rollers, respectively. The counterweight is connected to the connection means in an analogous manner. It is thus guaranteed that no additional stress acts on the guide rollers of the elevator cage.

A tensioning mass is preferably provided. This tensioning mass may preferably be attached to a fastening element or to a slide of the suspension. The additional rope is at all times tensioned in an optimal manner by the tensioning mass. While the additional rope is also tensioned by the connection means or (at least partially) tensioned by the weight force of the connection means, respectively, this tensioning of the additional rope by way of the connection means becomes less as the position of the elevator cage in the elevator shaft becomes lower. If the elevator cage is in the lowermost position, a correspondingly minor weight force of the connection means acts on the additional rope. In the lowest position of the elevator cage, the additional rope is thus not at all or only very slightly tensioned by the connection means. It is guaranteed by way of the tensioning mass that the additional rope is at all times under the tension required for faultless operation.

The additional rope is preferably fastened to the counterweight at a rope suspension ratio of 1:1. On account thereof, traveling noises and vibrations of the elevator cage as well as noises of the deflection roller(s) and of the additional rope are kept low in the elevator cage, even at comparatively high speeds. It should be noted that 2:1-type suspensions are also employable in the context described.

The additional rope is preferably configured from carbon fibers. A configuration as a plastics rope or as a metal rope (in particular as a steel rope) is also possible in an advantageous manner. An embodiment as a belt is also possible. In particular, the additional rope is configured from a strong, hard-wearing, and tear-resistant but nevertheless elongatable material. The additional rope must be designed in such a manner that it can compensate for the weight force of the complete connection means, in particular when the elevator cage is at the highest position. Here, a large difference in the stress on the additional rope by way of the connection means arises between the highest and lowest position of the elevator cage. This difference in particular leads to elongation of the additional rope. Carbon fibers are particularly expedient for withstanding this stress.

The at least one elevator cage expediently has a guide unit on which the elevator cage is displaceable in the elevator shaft. In this context, linear guides, in particular sliding guides, magnetic guides, pneumatic guides, etc. are particularly preferable.

It is particularly preferable that the elevator cage is configured having a number of guide rollers which interact with an elevator cage guide provided in the shaft, which in particular has a number of elevator cage rails. So that non-uniform forces and momentums acting on the elevator cage guide or on the guide rollers, respectively, may be avoided according to the invention, guide rollers of this type may be manufactured from particularly soft materials, such as from plastics or rubber, for example, on account of which the travel comfort of an elevator installation may be improved. In this context, metal rollers having a covering of soft plastics are also conceivable as guide rollers.

According to one preferred design embodiment of the invention, in order for the mentioned mobility in terms of the elevator cage to be provided, the suspension has a vertically displaceable slide or at least one articulation outside or partially outside the elevator cage projection. Other vertically movable elements are also conceivable. As an example, pivot mechanisms or articulation mechanisms which are provided on an elevator wall cage are to be mentioned.

According to a second preferred design embodiment, the suspension to this end has a rotatably mounted lever which is in particular pivotably mounted on the lower side or the upper side of the elevator cage (that is to say within the elevator cage projection) and which extends out of the elevator cage projection into a region beside the elevator cage projection).

These two preferred design embodiments make available in a simple manner in terms of construction desirable vertical play between the suspension and the elevator cage, such that changing weight forces on account of the connection means may be compensated for depending on the position of the elevator cage. On account thereof, variable elongation behavior of the support rope and of the additional rope is likewise effectively compensated for.

These preferred design embodiments will be discussed in detail hereunder with reference to the figures.

Further advantages and design embodiments of the invention are derived from the description and from the appended drawing.

It is to be understood that the features mentioned above and those yet to be discussed hereunder are not only able to be used in the combination stated in each case but also in other combinations or individually, without departing from the scope of the present invention.

The invention is schematically illustrated in the drawing by means of exemplary embodiments and will be described in detail in the following with reference to the drawing.

### DESCRIPTION OF THE FIGURES

FIG. 1a by means of a schematic illustration shows an elevator installation of the prior art;

FIG. 1 schematically shows a preferred design embodiment of an elevator installation according to the invention;

FIG. 2 schematically shows a further preferred design embodiment of an elevator installation according to the invention;

FIG. 3 schematically shows a further preferred design embodiment of an elevator installation according to the invention, having a balance chain as a support-rope weight compensation means;

FIG. 4 schematically shows a further preferred design embodiment of an elevator installation according to the invention, having a suspended cable and a balance chain as a support-rope weight compensation means.

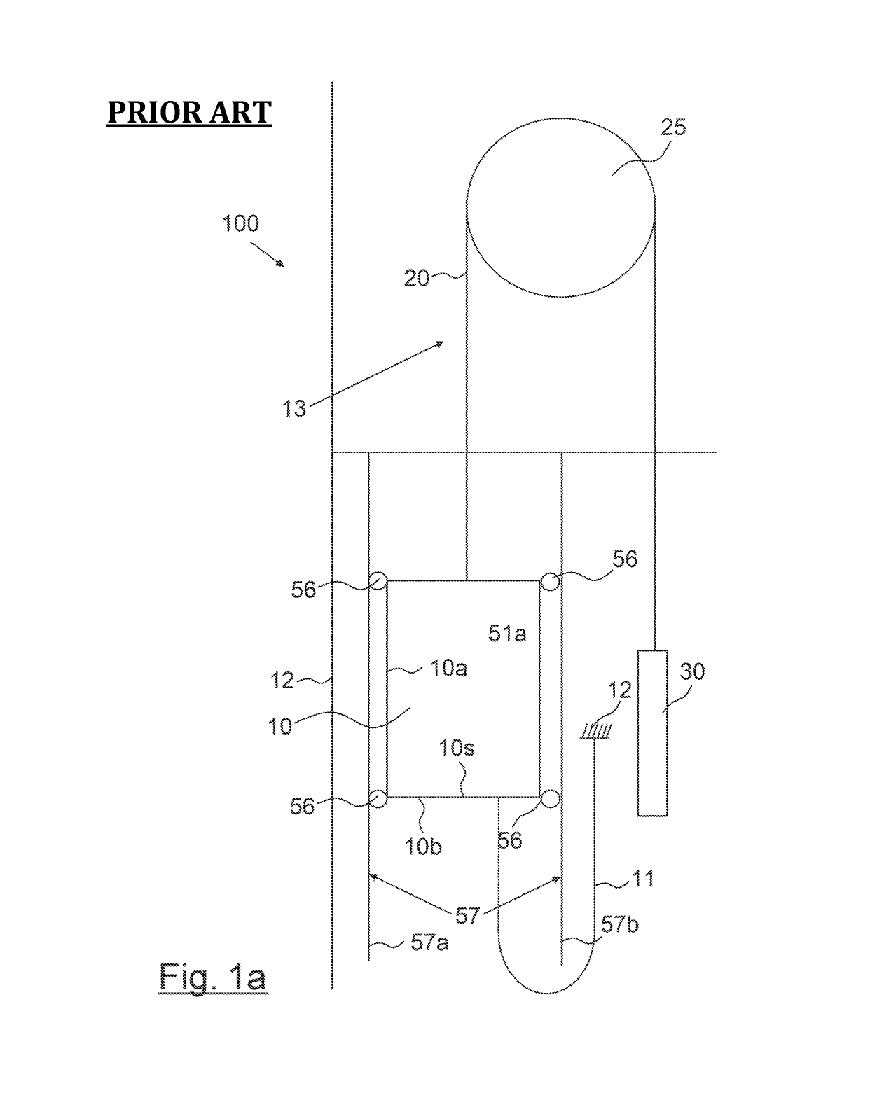

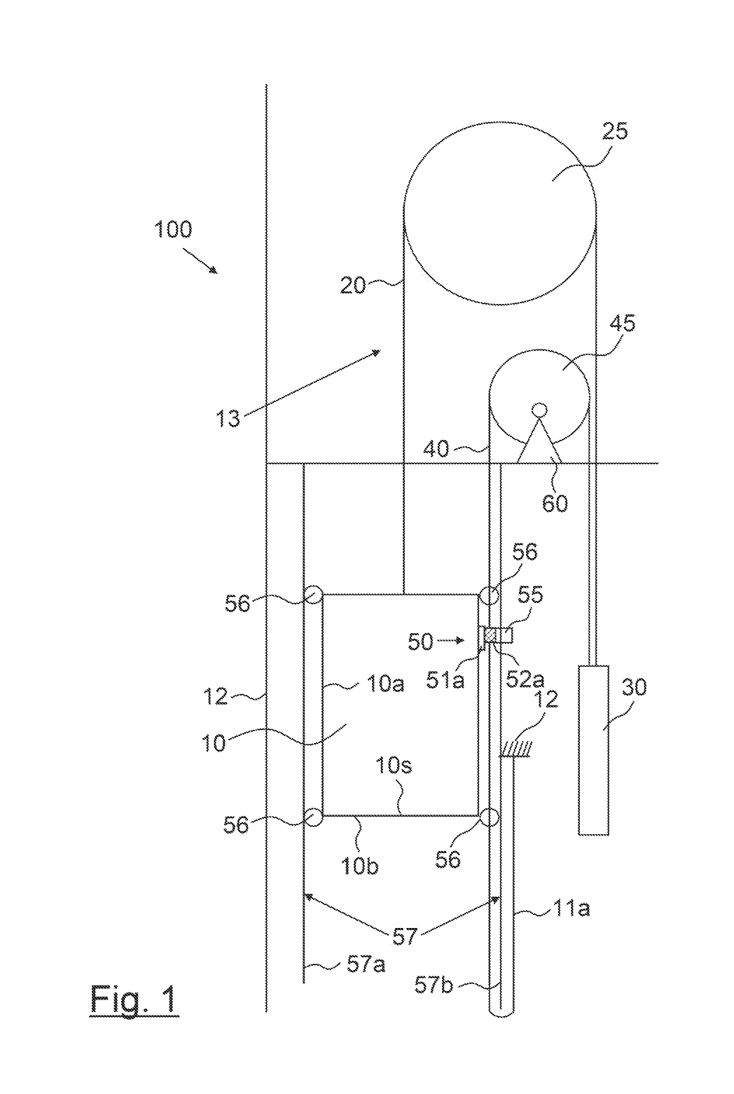

FIG. 1a shows a schematic illustration of an elevator installation 100. Here, an elevator cage 10 is suspended from a support rope 20. The elevator cage is displaceable within the elevator shaft 12 which is only schematically indicated. The elevator cage 10 has elevator cage walls of which one is referenced with 10a, and an elevator cage lower side 10b. A centric region of the lower side 10b or of the elevator cage base, respectively, that corresponds to the center of gravity of the elevator cage, is referenced with 10s. The support rope 20 is guided over a drive pulley 25 (and optionally over deflection rollers not illustrated in detail) and is connected to a counterweight 30. The drive pulley 25 here is schematically illustrated and may also comprise a plurality of individual rollers. The elevator cage is configured having guide rollers 56 which are displaceable along an elevator cage guide 57 which has rails 57a, 57b, for example. According to the invention, the guide rollers 56 may be manufactured from a very soft material or else have a covering of a very soft material, for example suitable plastics.

A connection means 11 is provided on the lower side of the elevator cage 10b. The first elevator cage-side end of the connection means 11 here is disposed on the elevator cage 10. The second end of the connection means may either be disposed on the counterweight 30 (not illustrated) or on the shaft 12. The connection means may be a suspended cable or a balance chain. Should the connection means be a suspended cable, the second end is typically connected to the shaft 12. However, should the connection means 11 be a balance chain, the second end is typically connected to the counterweight 30. The issue of a variable proportion of the weight force of the connection means 11 acting on the elevator cage, depending on the position of the elevator cage 10, arises in both cases. The higher the position of the elevator cage 10 in the shaft, the higher the proportion of the weight force of the connection means 11 acting on the elevator cage. On account of the required bending radius of the connection means 11, the first end of the connection means is mostly disposed in a decentralized manner and thus not in the center of gravity 10s of the elevator cage base. Depending on the position of the elevator cage in the elevator shaft 10, there thus results non-uniform distribution of the force and momentum on the guide rollers 56.

A preferred design embodiment of an elevator installation according to the invention is schematically illustrated in FIG. 1 and referenced with 100. In this embodiment, the connection means is configured as a suspended cable 11a.

An elevator cage 10 is suspended from a support rope 20. The elevator cage 10 has vehicle walls of which one is referenced with 10a, and a lower side of the elevator cage 10b. A centric region of the lower side 10b or of the elevator cage base, respectively, which corresponds to the center of gravity of the elevator cage, is referenced with 10s. The support rope 20 is guided over a drive pulley 25 (and optionally over deflection or deflection rollers not illustrated in detail), and is connected to a counterweight 30. The drive pulley 25 here is schematically illustrated and may also comprise a plurality of individual rollers. The elevator cage is configured having guide rollers 56 which are displaceable along an elevator cage guide 57 which has rails 57a, 57b, for example. According to the invention the guide rollers 56 may be manufactured from a very soft material, or else have a covering of a very soft material, for example suitable plastics.

A suspended cable 11a serves for supplying the elevator cage 10 with electric power and for exchanging data. A first end of the suspended cable 11a is fastened in the elevator shaft. The elevator shaft here for reasons of clarity is only schematically indicated by the reference sign 12. The suspended cable 11a in particular is fastened to a wall of the elevator shaft 12. The other end of the suspended cable 11a is not directly fastened to the elevator cage 10 in a mechanical manner but is connected to a suspension 50 which is configured on the elevator cage 10.

In FIG. 1 the suspension 50 is configured according to a first preferred design embodiment of the invention. The suspension 50 here comprises a slide 51a which is vertically displaceable in a guide on the elevator cage 10, and a fastening element 52a which is configured on said slide 51a. It is to be noted that other elements which make available vertical mobility are also usable. For example, a lever which is pivotable on the wall of the elevator cage may be provided in place of the slide 51a. The suspended cable 11a is fastened to the fastening element 52a or is suspended therefrom, respectively. On account of the vertical displaceability of the slide 51a, the fastening element 52a here is de-linked from the elevator cage 10 in terms of vertical force. The vertically displaceable slide 51a furthermore serves for horizontal guiding of the suspended cable 11a. The suspended cable 11a is secured by way of the suspension 50, and the supply of electric power to the elevator cage 10 and the exchange of data therewith is thus guaranteed.

Furthermore, an additional rope 40 is fastened to the fastening element 52a. The additional rope 40 serves for compensating for the weight force of the suspended cable 11a. The weight force of the suspended cable 11a acts on the suspension 50 in the vertical downward direction, when viewed using the example of FIG. 1. The additional rope 40 is now fastened to the suspension 50 and in the elevator shaft in such a manner that a force acts on the suspension 50 that counteracts the weight force of the suspended cable 11a, as is to be discussed hereunder. This force is thus intended to act on the suspension in a vertical upward direction.

The additional rope 40 is guided over at least one deflection roller 45. A plurality of deflection rollers 45 may also be provided for the additional rope. In particular, two deflection rollers 45 are typically provided here. The additional rope 40 is furthermore fastened to the counterweight 30. The deflection rollers (and/or the drive pulley 25) are/is preferably fastened in the machine room 13 or else in the shaft head, this in FIG. 1 being indicated by the reference sign 60. It is likewise possible for the deflection roller 45 and/or the drive pulley 25 to be provided in a machine room in the shaft head. Preferably, the additional rope 40 is guided toward the counterweight 30 at a rope suspension ratio of 1:1. 2:1-type suspensions are also conceivable.

The additional rope 40 or the counterweight 30, respectively, compensates for the weight force of the suspended cable 11a. The weight force of the suspended cable 11a is thus de-linked from the elevator cage 10. The vertically displaceable slide 51a is preferably configured so as to be displaceable in a bearing-type guide, in a sliding guide, or in a spindle roller bearing on the elevator cage 10. In the case of a lever providing vertical displaceability, a rotary joint provided on the elevator cage wall is advantageously employable. On account of the suspension 50 being configured having the vertically displaceable slide 51a and the fastening element 52a, it is guaranteed that no force acting in the vertical direction is introduced onto the elevator cage 10 and consequently no resulting torque generates any force acting on the guide rollers 56.

The additional rope 40 is tensioned by the weight force of the suspended cable 11a that acts on the additional rope 40. Additionally, a tensioning mass 55 may also be fastened to the fastening element 52a. By way of the tensioning mass 55 it is ensured that the additional rope 40 is optimally tensioned at every position of the elevator cage 10 in the elevator shaft 12.

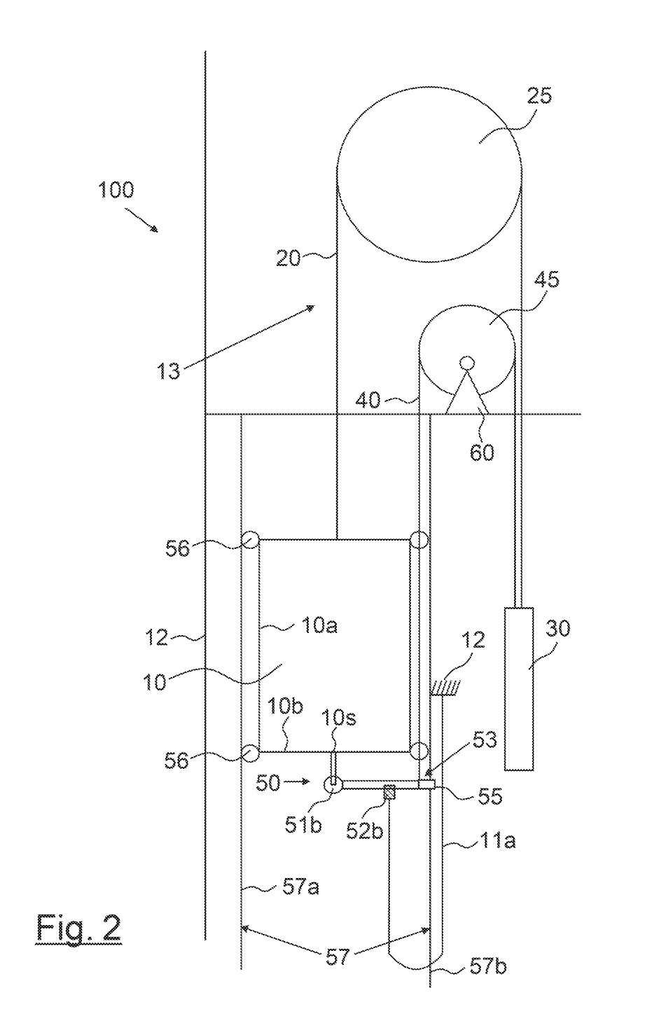

An elevator installation 100 is illustrated in FIG. 2 in an analogous manner to FIG. 1. Same reference signs here refer to identical or equivalent elements, and are not explained again.

A suspension 50 according to the second preferred design embodiment of the invention is illustrated in FIG. 2. The suspension 50 has a lever 51b, which is rotatably mounted on the lower side of the elevator cage 10, and a suspension 52b. The suspended cable 11a is fastened to the suspension 52b or is suspended therefrom, respectively. The additional rope 40 is fastened to one end 53 of the rotatably mounted lever 51b. A tensioning mass 55 which preferably is configured on the rotatably mounted lever, in particular on the end 53 thereof, may also be provided in this design embodiment.

The rotatably mounted lever 51b is preferably fastened in a centric region 10s on the lower side 10b of the elevator cage 10. According to this design embodiment of the suspension 50, depending on the positioning of the suspension 52b, a corresponding proportion of the weight force of the suspended cable 11a is introduced into the elevator cage. On account of the rotatably mounted lever 51b being fastened in the centric region 10s, this part of the weight force of the suspended cable 11a is however introduced into the elevator cage 10 in a centrical manner. The other proportion of the weight force is received by way of the additional rope 40. Thus, no undesirable torque acting on the elevator cage 10 by way of the weight force of the suspended cable 11a is created. There is thus no non-uniform distribution of force or non-uniform stress on the guide rollers 56, respectively.

Also on account of this design embodiment of the suspension 50, having the rotatably mounted lever 51b and the suspension 52b, no force acting in the vertical direction is introduced onto the elevator cage 10. A proportion of the weight force of the suspended cable 11a is compensated for by the additional rope 40, which in turn is guided over at least one deflection roller 45, also in this design embodiment. Part of the weight force of the suspended cable 11a is introduced into the elevator cage 10 in a centrical manner. Thus, the guide rollers 56 of the elevator cage 10 also according to this embodiment are in the optimal case not at all stressed but in any case only stressed to a minimum by the weight force of the suspended cable, depending on changing positions of the elevator cage.

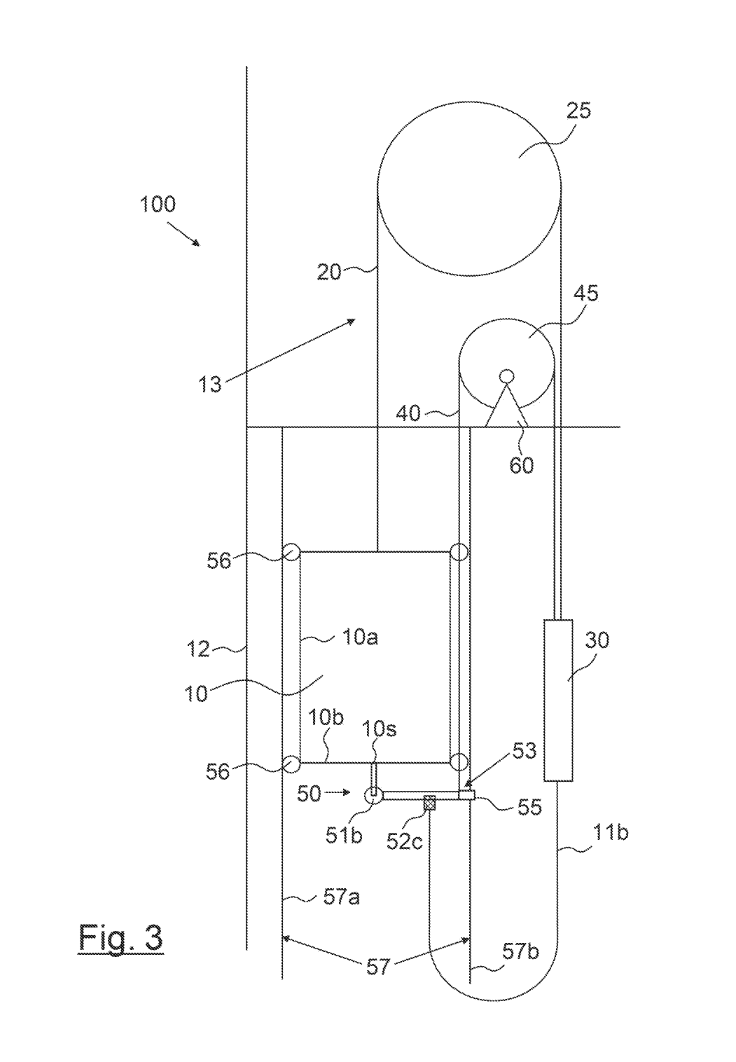

An elevator installation 100 is illustrated in FIG. 3 in an analogous manner to FIG. 2. Same reference signs here refer to identical or equivalent elements, and are not explained again. In this embodiment the connection means is configured as a balance chain 11b. The first elevator cage-side end of the balance chain 11b is connected to the suspension 50. The second end of the balance chain 11b is connected to the counterweight 30. Thus, the balance chain 11b compensates for the changing stress by the weight force of the support rope 20 in the case of changing positions of the elevator cage.

The suspension 50 has a lever 51b which is rotatably mounted on the lower side of the elevator cage 10, and a suspension 52c. The balance chain 11b is fastened to the suspension 52c or is suspended therefrom, respectively. The additional rope 40 is fastened to one end 53 of the rotatably mounted lever 51b. A tensioning mass 55 which preferably is configured on the rotatably mounted lever, in particular on the end 53 thereof, may also be provided in this design embodiment.

The rotatably mounted lever 51b is preferably fastened in a centric region 10s on the lower side 10b of the elevator cage 10. According to this design embodiment of the suspension 50, depending on the positioning of the suspension 52b, part of the weight force of the balance chain 11b is introduced into the elevator cage. On account of the rotatably mounted lever 51b being fastened in the centric region 10s, this part of the weight force of the balance chain is however introduced into the elevator cage 10 in a centrical manner. Thus, no undesirable torque acting on the elevator cage 10 by the weight force of the balance chain 11b, generating a force acting on the guide rollers 56, is created. There is thus no non-uniform distribution of force or non-uniform stress on the guide rollers 56, respectively.

Also on account of this design embodiment of the suspension 50, having the rotatably mounted lever 51b and the suspension 52c, no force acting in the vertical direction is introduced onto the elevator cage 10. A proportion of the weight force of the balance chain 11b is compensated for by the additional rope 40, which in turn is guided around at least one deflection roller 45, also in this design embodiment. The other proportion of the weight force of the balance chain 11b is introduced into the elevator cage 10 in a centrical manner. Thus, the guide rollers 56 of the elevator cage 10 also according to this embodiment are in the optimal case not at all stressed but in any case only stressed to a minimum by the weight force of the balance chain 11b, depending on changing positions of the elevator cage.

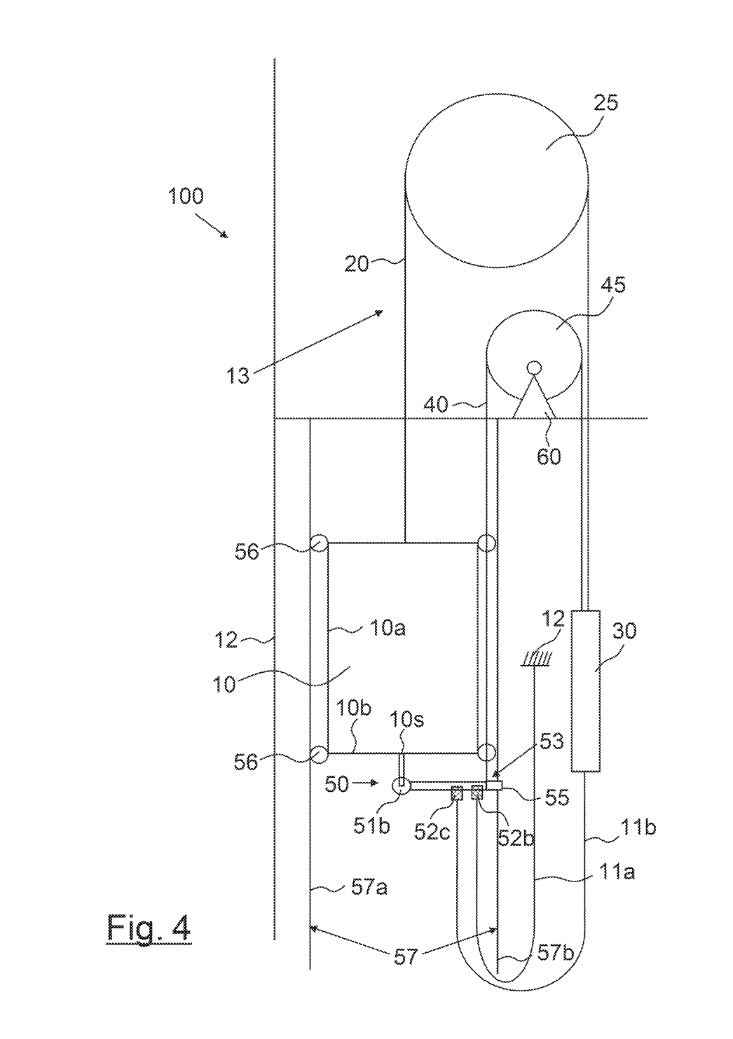

An elevator installation 100 is illustrated in FIG. 4 in an analogous manner to FIGS. 2 and 3. Same reference signs here refer to identical or equivalent elements, and are not explained again. This embodiment comprises both a suspended cable 11a as well as a balance chain 11b as connection means.

The suspension 50 has a lever 51b which is rotatably mounted on the lower side of the elevator cage 10. Both the suspended cable 11a as well as the balance chain 11b are fastened to the same lever 51b. To this end, the lever 51b has a suspension 52b for the suspended cable 11a, and a suspension 52c for the balance chain 11b. The in each case first elevator cage-side end of the suspended cable 11a or of the balance chain 11b is fastened to the two suspensions 52b and 52c, respectively. The second end of the suspended cable 11a is connected to the shaft 12. The second end of the balance chain 11c is connected to the counterweight. The additional rope 40 is fastened to an end 53 of the rotatably mounted lever 51b. A tensioning mass 55 which preferably is configured on the rotatably mounted lever, in particular on the end 53 thereof, may also be provided in this design embodiment.

The rotatably mounted lever 51b is preferably fastened in a centric region 10s on the lower side 10b of the elevator cage 10. According to this design embodiment of the suspension 50, depending on the positioning of the suspensions 52b and 52c, part of the weight force of the suspended cable 11a and of the balance chain 11b is introduced into the elevator cage. On account of the rotatably mounted lever 51b being fastened in the centric region 10s, this proportion of the weight force is however introduced into the elevator cage 10 in a centrical manner. Thus, no undesirable torque acting on the elevator cage 10 by the weight force of the two connection means, generating a force acting on the guide rollers 56, is created. There is thus no non-uniform distribution of force or non-uniform stress on the guide rollers 56, respectively.

Also on account of this design embodiment of the suspension 50, having the rotatably mounted lever 51b and the suspensions 52b and 52c, no force acting in the horizontal direction is introduced onto the elevator cage 10. A proportion of the weight force of the two connection means, the suspended cable 11a and the balance chain 11b, is compensated for by the additional rope 40, which in turn is guided around at least one deflection roller 45, also in this design embodiment. Thus, the guide rollers 56 of the elevator cage 10 also according to this embodiment are in the optimal case not at all stressed but in any case only stressed to a minimum by the weight force of the suspended cable 11a and of the balance chain 11b, depending on changing positions of the elevator cage.

### LIST OF REFERENCE SIGNS

100 Elevator installation
10 Elevator cage
10a Elevator cage wall
10b Lower side of elevator cage
10s Center of gravity/center of elevator cage base
11 Connection means
11a Suspended cable
11b Balance chain
12 Elevator shaft/wall of elevator shaft
13 Machine room/shaft head
20 Support rope
25 Drive pulley
30 Counterweight
40 Additional rope
45 Deflection roller
50 Suspension
51a Vertically displaceable slide
52a Fastening element
51b Rotatably mounted lever
52b Suspension of suspended cable
52c Suspension of balance chain
53 End of the rotatably mounted lever with rope suspension
55 Tensioning mass
56 Guide rollers
57 Guide
57a Rails
57b Rails
60 Fastening of the deflection roller in the machine room or in the shaft head

1.-18. (canceled)

19. An elevator system comprising:
an elevator cage that is displaceable in an elevator shaft;
a suspension disposed on the elevator cage;
a connection means that has a first elevator cage-side end and a second end, wherein the first elevator cage-side end is fastened to the suspension on the elevator cage; and
a support unit that exerts a force on the suspension that counteracts a force acting on the suspension attributable to a mass of the connection means.

20. The elevator system of claim 19 wherein the support unit is positioned at least partially outside a vertical projection of the elevator cage.

21. The elevator system of claim 19 wherein the suspension is vertically movable relative to the elevator cage.

22. The elevator system of claim 19 wherein the support unit comprises a rope, a deflection roller, and a counterweight, wherein a first end of the rope is fastened to the counterweight, wherein the rope is guided over the deflection roller.

23. The elevator system of claim 19 wherein the suspension comprises a slide that is vertically displaceable on the elevator cage.

24. The elevator system of claim 23 wherein the slide is configured so as to be displaceable in a bearing-type guide, in a sliding guide, or in a spindle roller bearing.

25. The elevator system of claim 19 wherein the suspension comprises a rotatably mounted lever.

26. The elevator system of claim 25 wherein the lever is rotatably mounted on a lower side of the elevator cage in a centric region of a base of the elevator cage or on a wall of the elevator cage.

27. The elevator system of claim 25 further comprising a tensioning mass disposed on the rotatably mounted lever or a fastening element that fastens the first elevator cage-side end of the connection means to the suspension on the elevator cage.

28. The elevator system of claim 19 wherein the support unit comprises a rope, a deflection roller, and a counterweight, wherein a first end of the rope is fastened to the counterweight, wherein the rope is guided over the deflection roller, wherein the rope is suspended at a rope suspension ratio of 1:1.

29. The elevator system of claim 19 wherein the support unit comprises a rope, a deflection roller, and a counterweight, wherein a first end of the rope is fastened to the counterweight, wherein the rope is guided over the deflection roller, wherein the rope is comprised of carbon fibers.

30. The elevator system of claim 19 wherein the support unit comprises a rope, a deflection roller, and a counterweight, wherein a first end of the rope is fastened to the counterweight, wherein the deflection roller is disposed in a machine room and/or a shaft head of the elevator shaft.

31. The elevator system of claim 19 wherein the elevator cage is displaceable in the elevator shaft while using a guide unit.

32. The elevator system of claim 31 wherein the guide unit is configured as a linear guide.

33. The elevator system of claim 31 wherein the guide unit is configured as a sliding guide, a magnetic guide, or a pneumatic guide.

34. The elevator system of claim 19 further comprising a plurality of guide rollers disposed along the elevator cage, wherein the plurality of guide rollers interact with an elevator cage guide disposed in the elevator shaft.

35. The elevator system of claim 19 wherein the connection means comprises a suspended cable, wherein the second end of the connection means is connected to the elevator shaft.

36. The elevator system of claim 19 wherein the connection means comprises a balance chain or a balance belt.
